(19) United States
(12) Patent Application Publication
(10) Pub. No.: US 2007/0144876 A1
(43) Pub. Date: Jun. 28, 2007

(54) Button with multi-functions

(75) Inventor: Jang-Yan Hung, Kaohsiung City (TW)

Correspondence Address: RABIN & Berdo, PC, 1101 14TH STREET, NW, SUITE 500, WASHINGTON, DC, 20005, US

(73) Assignee: BenQ Corporation, Taoyuan Shien (TW)

(21) Appl. No.: 11/636,434

(22) Filed: Dec. 11, 2006

(30) Foreign Application Priority Data
Dec. 23, 2005 (TW) 94146190

(51) Int. Cl. H01H 27/10

(52) U.S. Cl. 200/42.01

(57) ABSTRACT

A button is applied to an electronic apparatus with a circuit board. The button includes a function part, at least a status switching part, a flexible member and a pressing part. The function part is disposed on the circuit board, and the status switching part is disposed on the circuit board. The pressing part is connected to the flexible member. When the user presses the pressing part by applying an external force, the function part makes electrical contact with the circuit board to activate a specific function. If the external force is increased, the status switching part will make electrical contact with the circuit board to activate another specific function.

### BUTTON WITH MULTI-FUNCTIONS

This application claims the benefit of Taiwan application Serial No. 94146190, filed Dec. 23, 2005, the subject matter of which is incorporated herein by reference.

### BACKGROUND OF THE INVENTION

1. Field of the Invention

The invention relates in general to a button, and more particularly to a button generating multiple functions according to the force applied by a user.

2. Description of the Related Art

Living in today's society where information technology grows fast and advances rapidly, one does not have to use physical medium such as disc or tape when one wants to listen to music. Rather, music is converted into digital form and sold on on-line music shops, and various types of portable digital music players become available on the market every year. Digital music players having features of slimness, lightness, compactness, large storage and versatile functions have become mainstream product in the entertainment market and gained large market share.

Referring to FIG. 1, an exploded view of a conventional digital music player is shown. The digital music player 100 includes a circuit board 110, a play button 120, a fast-forward button 130, a flexible member 131, a rewind button 140 and a function part 150. If the user would like to shift to play a particular segment when listening to the music, the user will apply an external force on the fast-forward button 130, then the external force will be transmitted to the function part 150a via the flexible member 131, such that the function part makes electrical contact with the circuit board 110 to activate the fast-forwarding function.

However, in a conventional digital music player, one button corresponds to only one function. When the user presses the fast-forward button 130, the digital music player fast-forwards at a specific rotation speed only. When the user presses the rewind button 140, the digital music player rewinds at a specific rotation speed only. Therefore, the user is unable to tune the digital music player to a favorite segment or frequency band at a faster rotation speed when the user is listening to the music or the radio program, which is indeed very inconvenient.

### SUMMARY OF THE INVENTION

It is therefore an object of the invention to provide a button. The button generates multiple functions according to the force applied by a user, such that the user can operate different functions by the same button.

The invention achieves the above-identified object by providing a button applied to an electronic apparatus with a circuit board. The button includes a function part, at least a status switching part, a flexible member and a pressing part. The function part is disposed on the circuit board, and the status switching part is disposed on the circuit board. The flexible member connects the function part with the status switching part. The pressing part is connected to the flexible member.

The invention further achieves the above-identified object by providing an electronic apparatus. The electronic apparatus includes a circuit board, a function part, at least a status switching part, a flexible member and a pressing part. The function part is disposed on the circuit board, and the status switching part is disposed on the circuit board and adjacent to the function part. The flexible member connects the function part with the status switching part. The pressing part is connected to the flexible member.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is an exploded view of a conventional digital music player;

FIG. 2A is an exploded view of an electronic apparatus according to a first embodiment of the invention;

FIG. 2B is a diagram of a button at a normal status;

FIG. 2C is a diagram of a button at a first deformation;

FIG. 2D is a diagram of a button at a second deformation;

FIG. 2E is a diagram of a button with a supporting part; and

FIG. 3 is a diagram of a button with two status switching parts according to a second embodiment of the invention.

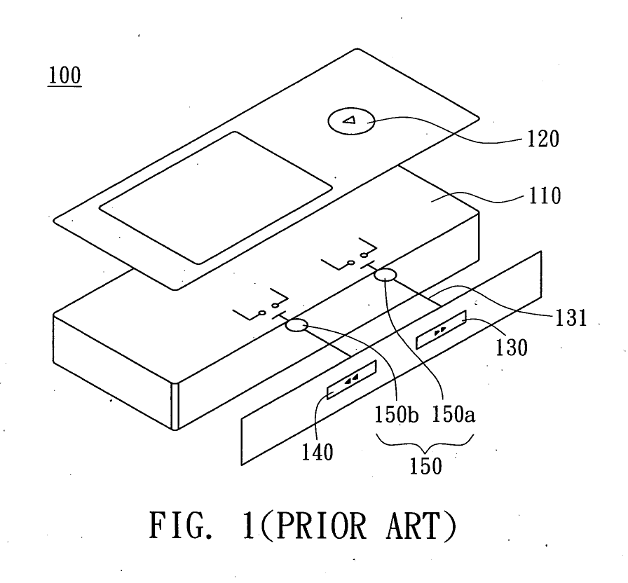

### DETAILED DESCRIPTION OF THE INVENTION

### First Embodiment

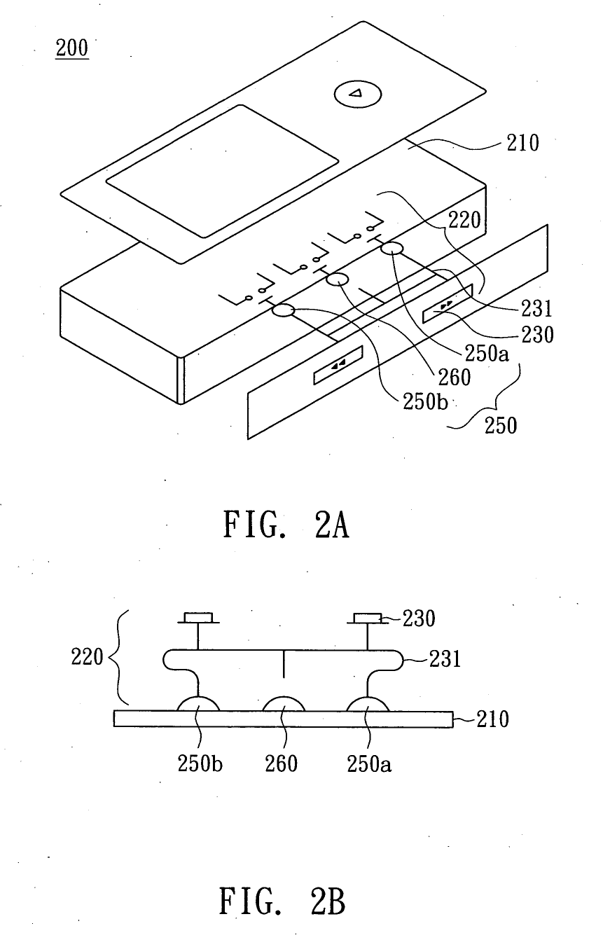

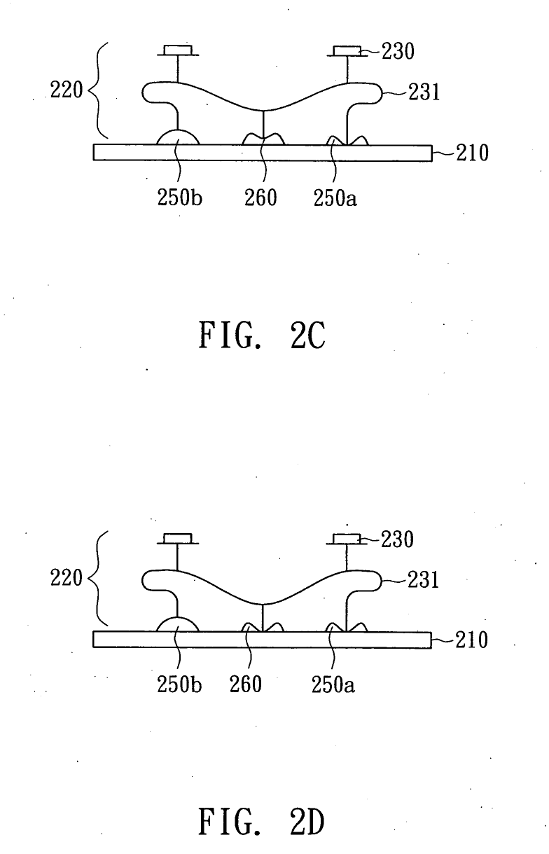

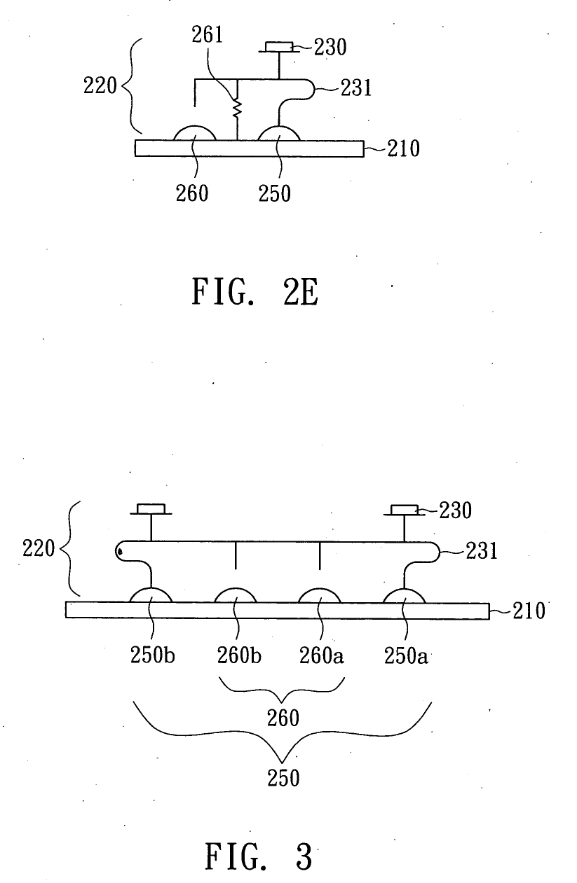

Referring to FIG. 2A, an exploded view of an electronic apparatus according to a first embodiment of the invention is shown. Examples of the electronic apparatus 200 include a digital music player. The digital music player includes a circuit board 210 and a button 220. The button includes a pressing part 230, a flexible member 231, a function part 250 and a status switching part 260. The function part 250 is disposed on the circuit board 210. The status switching part 260 is disposed on the circuit board 210 and adjacent to the function part 250. The pressing part 230 is connected to the flexible member 231. The flexible member 231 is preferably made of metal or plastic. Both the function part 250 and the status switching part 260 are made of metal dome.

Referring to FIG. 2B-2D, FIG. 2B is a diagram of a button at a normal status before an external force is applied thereto; FIG. 2C is a diagram of a button at a first deformation; and FIG. 2D is a diagram of a button at a second deformation. When the user presses the pressing part 230, such as the fast-forward button, the external force is transmitted to the function part 250a and the status switching part 260 via the flexible member 231. The function part 250a is closer to the point of application than the status switching part 260, so the function part 250a generates a larger deformation when being pressed as shown in FIG. 2C. This deformation is a first deformation for indenting the function part 250a to make electrical contact with the circuit board 210. At this moment, the status switching part 260 has not made electrical contact with the circuit board 210 yet, whereby the fast-forward function is determined. If the user increases the external force on the pressing part 230, the flexible member 231 will generate a larger bending deformation, such that the status switching part 260 generates a second deformation for indenting the status switching part 260 downward to make electrical contact with the circuit board 210, as shown in FIG. 2D. Meanwhile, the function part 250a still remains in contact with the circuit board 210, whereby the high speed fast-forward function is determined. The pressing part 230 is not limited to a fast-forward button, but rather, the pressing part 230 can be a speed variation button for increasing the rotation speed. Thus, the pressing part 230 becomes a button with multiple functions.

When the above button is the play button and the user presses the play button by applying an external force, the digital music player will begin playing music. If the external force is increased, then the function similar to the fast-forward button is generated to turn the music forward to a particular segment.

Referring to FIG. 2E, a diagram of a button with a supporting part is shown. In the present embodiment of the invention, the button 220 is further equipped with a supporting part 261 for preventing the flexible member 231 from being over deformed. Examples of the supporting part include a spring positioned between the function part 250 and the status switching part 260 for supporting the flexible member 231.

### Second Embodiment

Referring to FIG. 3, a diagram of a button with two status switching portions according to a second embodiment of the invention is shown. What differs with the first embodiment is that the button of the present embodiment has three functions. In the second embodiment, the button 220 is further equipped with a second status switching portion to activate another specific function. In this way, the button is enabled to generate more than two functions. When the user presses the pressing part 230, the external force is transmitted to the function part 250a and the status switching part 260 via the flexible member 231. The function part 250a is closer to the point of application than the status switching part 260, so the function part 250a generates a larger deformation. The deformation is the first deformation for indenting the function part 250a downward to make electrical contact with the circuit board 210. Meanwhile, the status switching part 260 has not yet made electrical contact with the circuit board 210, whereby the first function is determined. If the user increases the external force on the pressing part 230, then the flexible member 231 generates a larger bending deformation, such that the first status switching portion 260a generates a second deformation for indenting the first status switching portion 260a downward to make electrical contact with the circuit board 210. Meanwhile, the function part 250a still remains in contact with the circuit board 210, whereby the second function is determined. If the user increases the external force on the pressing part 230, then the flexible member 231 generates an even larger bending deformation, such that the second status switching portion 260b generates a third deformation for indenting the second status switching portion 260b downward to make electrical contact with the circuit board 210. Meanwhile, the function part 250a and the first status switching portion 260a still remains in contact with the circuit board 210, whereby the third function is determined. Similarly, the button of the invention can be equipped with several status switching portions to activate several specific functions according to the user's needs, not only providing the user with more convenience but also saving panel space for the electronic apparatus.

In the above two embodiments, the button can be applied to the pressing part of the shutter of a digital camera or other electronic products. For example, the user applies an external force to press the pressing part of the shutter to generate a focusing function, and if the external force is increased, the shooting function is activated.

The button disclosed in the above two embodiments of the invention is applied to the electronic apparatus. The button generates multiple functions according to the force applied thereto by the user. That is, a button can-generate several functions, not only reducing the number of buttons disposed on the panel of the electronic apparatus, but also saving space for the panel. The user does not need to spend time searching for the buttons, hence providing the user with more convenience.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A button applied to an electronic apparatus with a circuit board, the button comprising:
a function part disposed on the circuit board;
at least a status switching part disposed on the circuit board;
a flexible member; and
a pressing part connected to the flexible member;
wherein when an external force is applied to the pressing part, the flexible member transmits the external force to the function part, such that the function part makes electrical contact with the circuit board to activate a specific function;
wherein when the external force is increased, the function part remains in contact with the circuit board, the flexible member transmits the increased external force to the status switching part, such that the status switching part makes electrical contact with the circuit board to activate another specific function.

2. The button according to claim 1, wherein the flexible member is connected with the function part for generating a first bending deformation to indent the function part downward.

3. The button according to claim 2, wherein the flexible member is for generating a second bending deformation to come into contact with the status switching part and further indent the status switching part downward.

4. The button according to claim 1, wherein the status switching part comprises a first status switching portion and a second status switching portion, and the increased external force transmitted to the status switching part is first transmitted to the first status switching portion, then to the second status switching portion.

5. The button according to claim 1, wherein the function part is a metal dome.

6. The button according to claim 1, wherein the status switching part is a metal dome.

7. The button according to claim 1 further comprising a supporting part positioned between the function part and the status switching part.

8. The button according to claim 5, wherein the supporting part is disposed on the circuit board for supporting the flexible member.

9. The button according to claim 1, wherein the flexible member is made of plastics.

10. The button according to claim 1, wherein the flexible member is made of metal.

11. The button according to claim 1, wherein the button is a fast-forward button.

12. The button according to claim 10, wherein the button further is a speed variation button.

13. The button according to claim 1, wherein the button is a play button.

14. An electronic apparatus, comprising:
a circuit board; and
a button, comprising:
a function part disposed on the circuit board;
a status switching part disposed on the circuit board and adjacent to the function part;
a flexible member; and
a pressing part connected to the flexible member;
wherein when an external force is applied to the pressing part, the flexible member transmits the external force to the function part, such that the function part makes electrical contact with the circuit board to activate a specific function;
wherein when the external force is increased, the function part remains in contact with the circuit board, the flexible member transmits the increased external force to the status switching part, such that the status switching part makes electrical contact with the circuit board to activate another specific function.

15. The electronic apparatus according to claim 14, wherein the flexible member is connected with the function part for generating a first bending deformation to indent the function part downward.

16. The electronic apparatus according to claim 15, wherein the flexible member is for generating a second bending deformation to come into contact with the status switching part and further to indent the status switching part downward.

17. The electronic apparatus according to claim 14, wherein the status switching part comprises a first status switching portion and a second status switching portion, and the increased external force transmitted to the status switching part is first transmitted to the first status switching portion, then to the second status switching portion.

18. The electronic apparatus according to claim 14, wherein the function part is a metal dome.

19. The electronic apparatus according to claim 14, wherein the status switching part is a metal dome.

20. The electronic apparatus according to claim 14, wherein the button further comprises a supporting part positioned between the function part and the status switching part.

21. The button according to claim 20, wherein the supporting part is disposed on the circuit board for supporting the flexible member.

22. The electronic apparatus according to claim 14, wherein the flexible member is made of plastics.

23. The electronic apparatus according to claim 14, wherein the button is a fast-forward button.

24. The electronic apparatus according to claim 14, wherein the button is a play button.

25. The electronic apparatus according to claim 14, wherein the electronic apparatus is a digital camera.

26. The electronic apparatus according to claim 14, wherein the electronic apparatus is a music player.
